(19) United States
(12) Patent Application Publication
(10) Pub. No.: US 2014/0202947 A1
(43) Pub. Date: Jul. 24, 2014

(54) Liquid Filter

(71) Applicant: MANN+HUMMEL GMBH, Ludwigsburg (DE)

(72) Inventor: Christopher Marc Sturgess, Korntal (DE)

(73) Assignee: MANN+HUMMEL GMBH, Ludwigsburg (DE)

(21) Appl. No.: 14/221,440

(22) Filed: Mar. 21, 2014

Related U.S. Application Data
(63) Continuation of application No. PCT/EP2012/067254, filed on Sep. 5, 2012.

(30) Foreign Application Priority Data
Sep. 21, 2011 (DE) 10 2011 113 830.0

(51) Int. Cl. B01D 35/16

(52) U.S. Cl. CPC B01D 35/16
USPC 210/248

(57) ABSTRACT

A liquid filter has a housing with an outlet line for liquid and a vent line, one being arranged in a drain housing socket on the housing. A closure element closes off outlet line and vent line. An annular space socket coaxially surrounds the drain housing socket outwardly and delimits with the drain housing socket an annular space to which the vent line or the outlet line is connected. The closure element has a collecting pot with bottom and a closure socket arranged at the bottom that fits within the annular space and is coaxially attached to the drain housing socket for axial movement. A sealing area on the bottom externally surrounds the drain housing socket. When the closure element is closed, the sealing area seals a free end face of the annular space socket. The fluid collecting pot has a liquid drain opening outside of the sealing area.

### CROSS-REFERENCE TO RELATED APPLICATIONS

This application is a continuation application of international application No. PCT/EP2012/067254 having an international filing date of 05 Sep. 2012 and designating the United States, the International Application claiming a priority date of 21 Sep. 2011, based on prior filed German patent application No. 10 2011 113 830.0, the entire contents of the aforesaid international application and the aforesaid German patent application being incorporated herein by reference.

### BACKGROUND OF THE INVENTION

The invention concerns a liquid filter for a liquid, in particular for a fuel, in particular a diesel fuel, in particular of an internal combustion engine in particular of a motor vehicle, comprising a housing which, in a normal operating position of the liquid filter, has spatially at the bottom end at least one outlet line for liquid contained in the housing and at least one vent line, and comprising a closure element for the at least one outlet line and the at least one vent line that is arranged rotatable and/or insertable externally at the bottom end on the housing.

U.S. Pat. No. 6,258,269 B1 discloses a drain device for a liquid filter that has a female valve part that is monolithically formed with an end wall of a collecting vessel. The drain device has a tubular projection with a cylindrical sidewall and an inner end wall. The end wall comprises a plug and a venting opening radially arranged outside of the plug. A drain opening is arranged in the end wall radially outside of the tubular projection in the end wall. An annular sealing surface is arranged radially outside of the drain opening. A threaded sleeve is arranged outside of the annular sealing surface. A male valve part is inserted into the female valve part. The male valve part comprises a valve body and a valve seal. The valve seal is arranged in the tubular projection and has a cylindrical sidewall which defines a vent line. The valve seal comprises moreover an inner end with a vent opening to the vent line. An annular seal surface is arranged radially outside of the sidewall of the valve seal. The seal surface of the valve member is seal-tight relative to the seal surface of the end wall of the vessel. The valve member has an outlet opening radially outside of the valve seal. The valve member comprises a threaded sleeve radially outside of the annular outlet opening in the valve body. The threaded sleeve of the valve body interacts with the threaded sleeve of the female valve part in such a way that the male valve part can be screwed into the female valve part and unscrewed from it.

The invention has the object to configure a liquid filter of the aforementioned kind comprising a closure element for opening and closing the at least one outlet line and comprising at least one vent line, which is of a simple configuration and can be mounted and actuated in a simple way. The closure element should be space-saving as much as possible. With the closure element, the outlet line should be opened and closed together with the vent line, if possible.

### SUMMARY OF THE INVENTION

This object is solved according to the invention in that, externally on the housing, a drain housing socket that comprises the at least one outlet line or the at least one vent line and an annular space socket coaxially surrounding it radially outwardly are arranged, which define an annular space with which the at least one vent line or the at least one outlet line is connected. The closure element comprises a fluid collecting pot which with its open side is facing the housing and has inwardly at its bottom a closure socket that fits within the annular space. The closure element is attached coaxially with the closure socket to the drain housing socket so as to be movable at least in axial direction for opening and closing the closure element. At the bottom of the fluid collecting pot, a sealing area is arranged which surrounds the drain housing socket radially outwardly with a circumferentially closed configuration and interacts indirectly or directly seal-tightly with the free end face of the annular socket in the closed state of the closure element. The fluid collecting pot, radially outside of the sealing area, has at least one outlet opening for the liquid.

According to the invention, there is thus a drain housing socket attached to the housing on which a closure socket of the closure element can be mounted by means of a rotary and/or plug-in connection. The rotary and/or plug-in connection can be a screw connection, a bayonet connection or a different kind of plug-in connection. The terms “axial”, “radial” and “circumferential side”, if not indicated otherwise, refer to a rotary and/or insertion direction of the closure element relative to the housing. The closure socket is immersed into the annular space which is located between the drain housing socket and the annular space socket. In the closed position of the closure element, the annular socket seal-tightly seals relative to the sealing area at the bottom surface of the fluid collecting pot of the closure element. One of the lines, preferably the at least one outlet line, is located in the interior of the drain housing socket. The other line, preferably the at least one vent line, opens into the annular space. By means of the at least one outlet line, liquid can be drained from the liquid filter. In particular when using the liquid filter for fuel, in particular for diesel fuel, water which may collect in a liquid collecting space in the lower area of the housing of the liquid filter, can be drained.

When draining liquid, in particular water, ambient air is supplied via the at least one vent line in order to prevent that in the liquid filter underpressure is generated which would impair drainage of the liquid. The annular space socket seals at the sealing area the at least one vent line as well as the at least one outlet line relative to an outer annular space between the sealing area and the circumferential wall of the fluid collecting pot. The outlet opening for the liquid is extending away from the outer annular space . Advantageously, the outlet opening can be arranged at the bottom of the fluid collecting pot, preferably at the lowest point. In this way, the liquid can be completely drained from the liquid collecting pot.

With only one sealing area, the at least one vent line as well as the at least one outlet line can be sealed relative to the exterior, in particular to the environment. In this connection, the end face of the annular space socket can be resting immediately on the sealing surface of the sealing area. Also, an additional seal can be provided between the sealing area and the end face of the annular socket so that the closure socket seals indirectly relative to the sealing area.

The drain housing socket, the annular space socket, and the closure socket are arranged in a space-saving way coaxially relative to each other substantially at one level. This has a positive effect on the constructive height of the liquid filter in axial direction. The space that is gained in this way in comparison to liquid filters known in the prior art can be employed for enlarging the interior of the housing, in particular a volume of the liquid collecting space at the bottom within the housing. Upon moving out the closure element in axial direction, the radial outer circumferential wall of the fluid collecting pot is moved away from the housing and in this way enlarges a gap at the open end face of the fluid collecting pot for supply of air. The at least one vent line and the at least one outlet line are connected, upon opening of the sealing device, with the outer annular space.

The attachment of the closure element is realized exclusively by means of the drain housing socket and the closure socket. For sealing, exclusively the annular space socket and the sealing area of the fluid collecting pot are used. In this way, the holding function and the sealing function are separate from each other. Accordingly, the holding function and the sealing function can be optimized with regard to their design independent of each other.

In an advantageous embodiment, the axial expansion of the annular space socket can be smaller than the axial expansion of the drain housing socket. In this way, for draining the liquid and for venting, a gap between the annular space socket and the sealing area can be opened when pulling out the closure element, without the closure element having to be separated completely from the drain housing socket. This simplifies the drainage process. Also, the closure element can thus not be lost as easily.

Advantageously, an annular seal, in particular a flat seal, can be arranged axially between the free end face of the annular space socket and the sealing area of the fluid collecting pot. By means of the annular seal, the sealing function can be improved. Flat seals can be mounted in a simple way. Moreover, flat seals can be produced in a simple and inexpensive way. Flat seals have moreover a minimal constructive height in axial direction. This has a positive effect on the ratio between space requirement and volume of the filter element.

In a further advantageous embodiment, the drain housing socket and/or the closure socket can have circumferentially at least one through opening for the liquid which in the closed state of the closure element is closed off with fluid-impermeable areas of the respective other socket and which upon opening of the closure element can be opened again. Circumferential through openings can be arranged advantageously at a spacing relative to the free end face of the respective socket. In this way, they can be opened while the other socket, respectively, can remain connected with the circumferential section in the area of the free end face. Accordingly, the circumferential through openings can be opened without the closure element having to be completely removed from the housing.

Moreover, advantageously the drain housing socket can have an outer thread and the closure socket can have an appropriate inner thread. In this way, a screw connection can be realized in a simple way. A screw connection can be opened continuously so that the connection between the at least one outlet line and the at least one vent line and the outer annular space can be opened uniformly and in a controlled fashion.

Advantageously, each opening of the at least one vent line in the interior of the housing in the normal operating position of the liquid filter can be spatially arranged above a lowermost opening of the at least one outlet line in the interior of the housing. Advantageously, all openings of the at least one vent line can be located spatially above a liquid level in the housing. In this way, it can be prevented that liquid can escape through the at least one vent line from the housing upon opening of the closure element. At least the lowermost opening of the outlet line in the interior of the housing can be arranged at the lowermost point of the housing. In this way, when using the liquid filter for fuel, in particular diesel fuel filter, possibly contained water which may collect in a water collecting chamber at the bottom of the housing can be drained without the lighter diesel oil which is floating on top escaping from the housing. The vent line as well as the outlet line can also have only one opening, which has the above mentioned properties, in the interior of the housing.

### BRIEF DESCRIPTION OF THE DRAWINGS

Further advantages, features, and details of the invention result from the following description in which an embodiment of the invention is explained in more detail with the aid of the drawing. A person of skill in the art will consider the features disclosed in the drawing, the description, and the claims in combination expediently also individually and combine them to other meaningful combinations.

FIG. 1 shows a section of a detail of a fuel filter for diesel fuel in the area of a drain device with an outlet line for water that has been separated by the fuel filter and a vent line which are closed off by a closure element.

FIG. 2 shows the fuel filter of FIG. 1 wherein herein the closure element is shown in the open position.

FIG. 3 shows the fuel filter of FIG. 1 without closure element.

FIG. 4 is an isometric illustration of the closure element of the fuel filter of FIG. 1.

In the Figures same components are provided with same reference characters.

### DESCRIPTION OF PREFERRED EMBODIMENTS

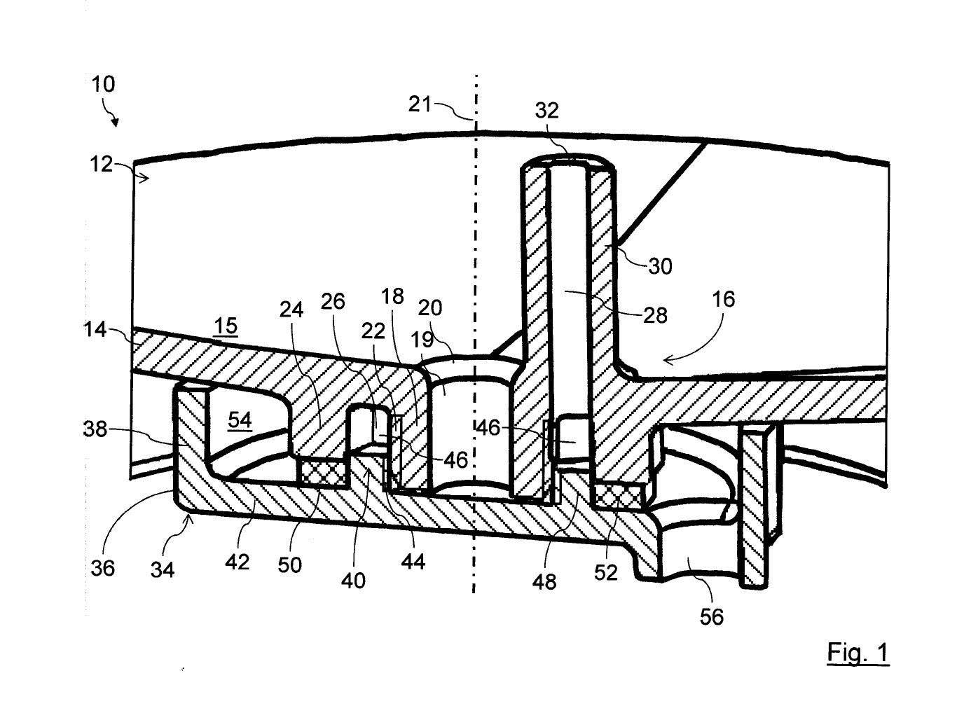

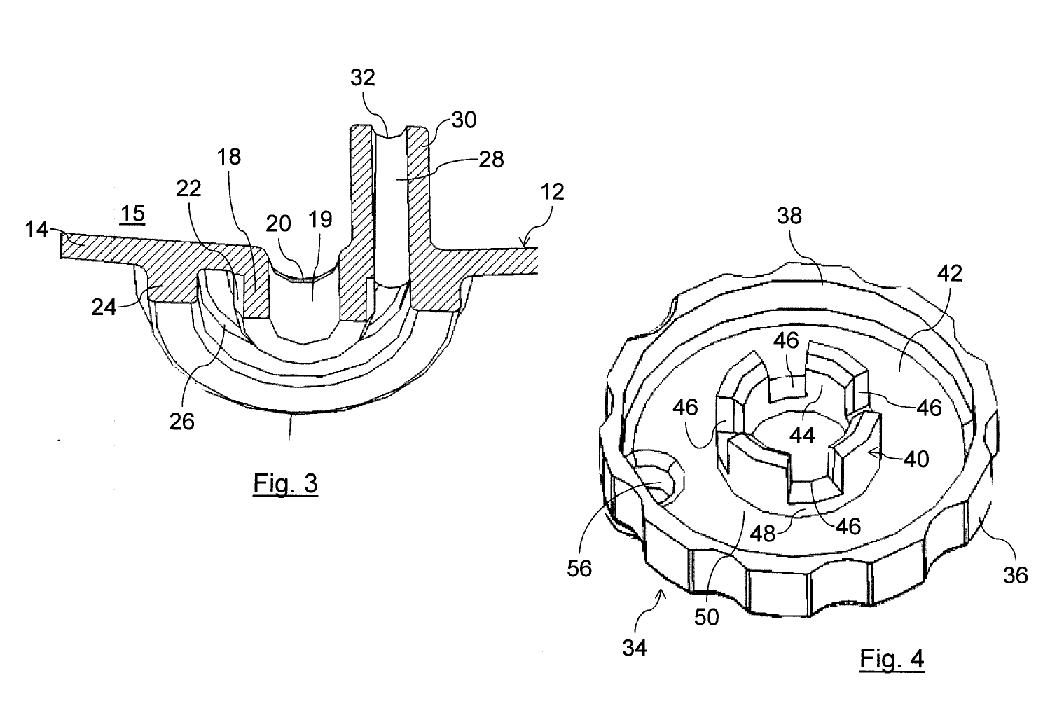

In FIG. 1, a detail view of a fuel filter 10 for liquid diesel fuel is shown in section. The fuel filter 10 is part of a fuel system of an internal combustion engine of a motor vehicle which is not of interest in this context. It serves for purifying the diesel fuel and separating water possibly contained in the diesel fuel. The fuel filter 10 has a filter housing 12 of which in FIG. 1 only a detail in the area of a housing bottom 14 is shown. A further detail view of the housing bottom 14 is shown in FIG. 3. The housing bottom 14 is made of plastic material, for example, according to an injection molding process.

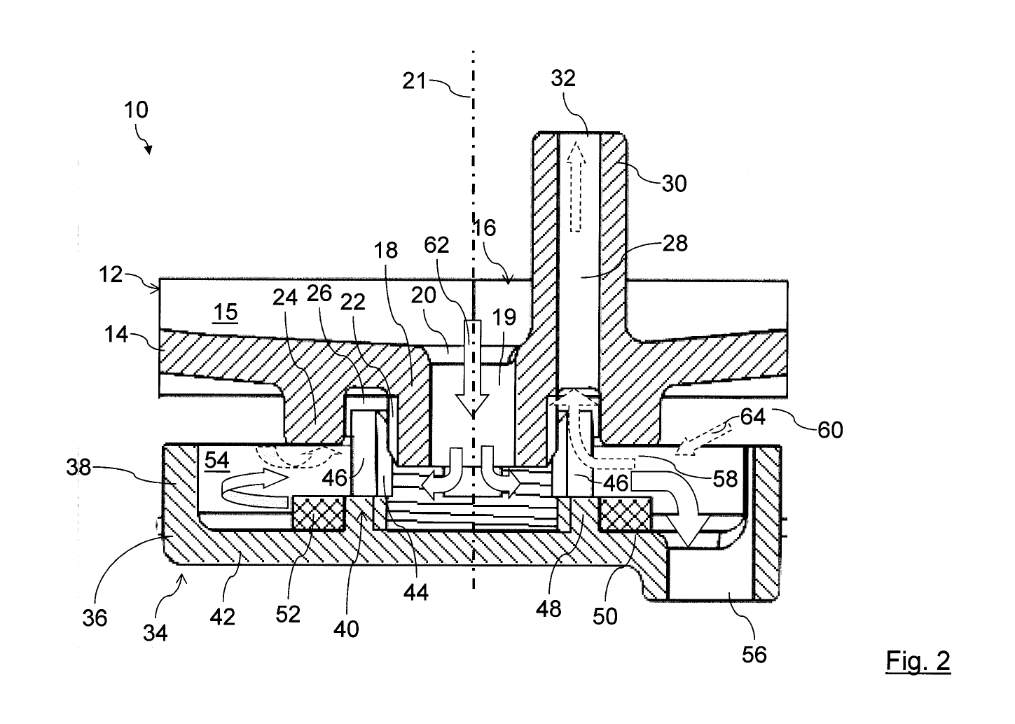

The filter housing 12 has an inlet for fuel to be purified and an outlet for purified fuel which are both not shown in FIG. 2. In the filter housing 12, a filter element, also not illustrated, is arranged which separates the inlet seal-tightly from the outlet. The fuel for purification must flow through the filter element in a way not of interest in this context. Possibly contained water in the fuel is separated in the process and collected in the area of the housing bottom 14 which, in normal operating position of the fuel filter 10 illustrated in FIG. 1, is arranged spatially at the bottom end. The area above the housing bottom 14 serves as a water collecting space 15. For draining the collected water, in the housing bottom 14 a drain device is provided that is indicated as a whole by 16.

The drain device 16 comprises a drain housing socket 18 which extends through the housing bottom 14 and which connects the water collecting space 15 with the environment, for example, a collecting device for the water which is located outside of the filter housing 12. An imaginary axis of the drain housing socket 18 extends, in the normal operating position of the fuel filter 10, axially to a vertical screw axis 21, relative to which a closure element 34 can be moved relative to the filter housing 12. When in the following “axial”, “radial” or “circumferential” is referred to, this relates to the screw axis 21, if nothing to the contrary is mentioned. The drain housing socket 18 has in its interior an outlet line 19 for the collected water. The outlet line 19 has an outlet opening 24 relative to the water collecting space 15. The drain housing socket 18 extends at the exterior side of the housing bottom 14. It is monolithic with the housing bottom 14. At its radial outer circumferential side, the drain housing socket 18 has an outer thread 22. The radial inner circumferential side of the drain housing socket 18 passes in the area of the outlet opening 20 continuously into the inner side of the housing bottom 14. The water that is collected in the water collecting space 15 can thus flow without any barrier through the outlet opening 20.

Radially externally, the drain housing socket 18 is surrounded by a coaxial annular space socket 24 which is also part of the drain device 16. The annular space socket 24 is monolithically connected with the housing bottom 14. The axial expansion of the annular socket 24, viewed from the housing bottom 14, is less than the axial expansion of the drain housing socket 18. The drain housing socket 18 projects thus past the annular space socket 24 in axial direction.

Radially between the drain housing socket 18 and the annular space socket 24 there is a radial inner annular space 26 which is delimited radially inwardly by the drain housing socket 18 and radially outwardly by the annular space socket 24. A vent line 28 of the drain device 16 opens into the inner annular space 26. The vent line 28 extends in the interior of a vent pipe 30 from the interior of the filter housing 12 to the inner annular space 26. An inner opening 32 of the vent pipe 30 in the interior of the filter housing 12 is located in the normal operating position of the fuel filter 10 spatially above the outlet opening 20. The vent line 28 extends eccentrically to the screw axis 21 parallel to the outlet line 19. The vent line 28 serves for venting the filter housing 12 upon drainage of the water through the outlet line 19. Through the vent line 28 ambient air can flow into the filter housing 12 in order to prevent underpressure in the filter housing 12.

The drain device 16 comprises moreover the closure element 34 with which the outlet line 19 and the vent line 28 can be closed. The closure element 34 is shown in detail in FIG. 4. For draining the water collected in the water collecting space 15, by means of the closure element 34 the drain line 19 and the vent line 28 can be opened. The closure element 34 comprises a cup-shaped collecting pot 36 for the drained water. The collecting pot 36 is open toward the housing bottom 14 of the filter housing 12. In the closed state of the closure element 34 illustrated in FIG. 1, the free end face of a radial outer circumferential wall 38 of the collecting pot 36 is contacting the outer side of the housing bottom 14.

The closure element 34 has a closure socket 40 which is monolithically formed on the side of the bottom 42 of the collecting pot 36 that is facing the interior of the collecting pot 36. The closure socket 40 has an inner thread 44 which matches the outer thread 22 of the drain housing socket 18. The inner diameter of the closure socket 40 corresponds to the outer diameter of the drain housing socket 18. By means of the closure socket 40 the closure element 34 is screwed onto the drain housing socket 18. The outer diameter of the closure socket 40 corresponds to the inner diameter of the annular space socket 24. The closure socket 40 is immersed, coaxially to the drain housing socket 18 and coaxially to the annular space socket 24, into the inner annular space 26. An axial expansion of the closure socket 40 is less than the axial expansion of the inner annular space 26. In the closed state of the closure element 34, the free end face of the drain housing socket 18 is within the closure socket 40 on the inner side of the bottom 42 of the collecting pot 36.

The closure socket 40 has four through openings 46 that in circumferential direction are uniformly distributed. The through openings 46 extend in axial direction, as illustrated in FIG. 4 from a fluid-impermeable circumferential area 48 of the closure socket 40 in the vicinity of the bottom 42 up to the free end face of the closure socket 40. In the closed state of the closure element 34 which is illustrated in FIG. 1, the fluid-impermeable area 48 overlaps the annular space socket 24 in axial direction. An axial overlap of the drain housing socket 18 with the closure socket 40 is greater than the axial overlap of the annular space socket 24 with the closure socket 40. In this way, when unscrewing the closure element 34, first the through openings 46 and thus the inner annular space 26 are opened relative to the outer annular space 54. Only once the closure element 34 is unscrewed farther, the inner annular space 26 is opened via the through openings 46 relative to the outlet line 19.

The closure socket 40 is surrounded radially externally by a sealing surface 50 which is located on the inner side of the bottom 42 of the collecting pot 36. In the closed state of the closure element 34, an annular seal 52 in the form of a flat seal is resting seal-tightly on the sealing surface 50. The free end face of the annular space socket 24 is resting seal-tightly on the side of the annular seal 52 which is facing away from the bottom 42 of the collecting pot 36.

Radially between the annular seal 52 or the sealing surface 50 and the annular space socket 24 on one side and the circumferential wall 38 on the other side, there is an outer annular space 54. A drain socket 56 passes downwardly from the outer annular space 54 through the bottom 42 of the collecting pot 36 to the exterior. The outlet socket 56 can be connected externally permanently, or only for a drainage process, with a collecting device for the water by means of which it can be prevented that water contaminated with fuel can reach directly the environment. In the closed state of the closure element 34, the annular seal 52 seals the interior annular space 26 and thus the venting line 28 and the outlet line 19 relative to the outer annular space 54 and thus to the exterior. Therefore, only this one annular seal 52 is required in order to seal the vent line 28 as well as the outlet line 19 relative to the exterior.

In order to drain collected water from the filter housing 12, the closure element 34, as shown in FIG. 2, is unscrewed somewhat from the drain housing socket 18. A gap 58 between the annular seal 52 and the end face of the annular space socket 24 is thus opened. Moreover, an air gap 60 between the end face of the circumferential wall 38 and the housing bottom 14 is opened. In other respects, the through openings 46 are opened first radially outwardly by the annular socket 24 and, upon further unscrewing, radially inwardly by the drain housing socket 18.

The water passes, indicated by arrows 62, from the water collecting space 15 through the outlet opening 20 into the outlet line 19 and from there into an area within the closure socket 40. From here, the water flows through the opened through openings 46 in a radial direction from the interior to the exterior into the inner annular space 26. From the inner annular space 26 the water passes through the gap 58 into the outer annular space 54. It exits from the outer annular space 54 through the outlet socket 56.

For preventing an underpressure in the filter housing 12 upon drainage of the water, air is sucked in from the environment, as indicated by dashed arrow 64, through the air gap 60 first into the outer annular space 54. From here, the air flows through the gap 58 into the interior annular space 26. From the interior annular space 26 the air flows into the vent line 28 and flows through the openings 32 into the interior of the filter housing 12. The air enters the interior of the filter housing 12 above the outlet opening 20.

Since upon opening of the closure element 34, the gap 58 connects first the inner annular space 26 and thus the venting line 28 with the outer annular space 54 and thus the environment, venting of the interior of the filter housing 12 is possible before the collected water can escape from the filter housing 12 via the outlet line 19. Accordingly, from the beginning no under pressure can be created in the filter housing 12 which could counteract drainage of the water. Only upon further unscrewing of the closure element 34, the through openings 46 are opened toward the outlet line 19 so that the water can drain.

In the above-described embodiment of a fuel filter 10 inter alia the following modifications are possible.

The invention is not limited to a fuel filter 10 for diesel fuel. Instead, it can be used also for different types of filters for liquids, for example, for other fuels, oil, or water. Preferably, the invention can be used in liquid filters in which the liquid is to be drained pressureless from a filter housing. The invention is also not limited to the use in internal combustion engines of motor vehicles. Instead, it can also be used for different kinds of internal combustion engines, for example, industrial motors.

The housing bottom 14, instead of being made of plastic material, can also be comprised of a different material, for example, metal.

The vent line 28, instead of being eccentric relative to the drain housing socket 18, can also extend within it. Instead, the outlet line 19 can then be provided outside of the drain housing socket 18.

It is also possible to have more than one vent line 28. Also, more than one outlet line 19 can be provided.

The annular seal 52, instead of being provided at the bottom 42 of the collecting pot 36, can also be connected to the end face of the annular space socket 24. It is also possible to eliminate the annular seal 52. Instead, the end face of the annular space socket 24 can be resting immediately seal-tightly on the sealing surface 50 of the closure element 34.

The annular seal 52, instead of being embodied as a flat seal, can also be a different kind of annular seal, for example, an O-ring seal or a profiled ring seal.

The drain housing socket 18, the venting pipe 30 and/or the annular space socket 24, instead of being monolithic with the housing bottom 14, can also be connected as separate parts fixedly with the latter, for example, by gluing or welding. The drain socket 56, instead of being monolithic with the collecting pot 36, can also be designed as a separate component and connected to the latter, for example, glued or welded.

In addition to the through openings 46 in the closure socket 40, appropriate through openings can be provided also in the drain housing socket 18 and/or in the annular space socket 24. It is also possible to provide more or fewer than four through openings 46. The through openings 46 can also be differently dimensioned and/or arranged.

Between the free end face of the circumferential wall 38 of the closure element 34 and the exterior side of the housing bottom 14 of the filter housing 12 an additional seal can be provided also. It can also be provided that the air gap 60 is opened even in the closed position of the closure element 34.

In addition, or alternative, to water, fuel can be drained also with the drain device 16.

Even though the present invention has been explained with the aid of various embodiments, it is not limited thereto but can be modified in many ways. For example, spring types other than the aforementioned ones can be employed.

What is claimed is:

1. A liquid filter for a liquid, the liquid filter comprising:
a housing having a bottom end in a normal operating position of the liquid filter;
at least one outlet line for liquid contained in the housing arranged at the bottom end;
at least one vent line arranged at the bottom end;
a closure element adapted to close off the at least one outlet line and the at least one vent line, wherein the closure element is arranged rotatable and/or insertable externally at the bottom end of the housing;
a drain housing socket, comprising the at least one outlet line or the at least one vent line, disposed externally on the housing;
an annular space socket disposed externally on the housing so as to coaxially surround the drain housing socket radially outwardly;
wherein the drain housing socket and the annular space socket delimit an annular space;
wherein the at least one vent line or the at least one outlet line is connected to the annular space;
wherein the closure element has a fluid collecting pot with an open side that is facing the housing;
wherein the fluid collecting pot has a bottom;
wherein the closure element has a closure socket that is arranged at an inner side of the bottom of the fluid collecting pot, wherein the closure socket fits within the annular space;
wherein the closure socket is coaxially attached to the drain housing socket so as to be moveable at least in axial direction for opening and closing the closure element;
wherein a sealing area is arranged on the bottom of the fluid collecting pot and has a circumferentially closed configuration that radially externally surrounds the drain housing socket, wherein, in a closed state of the closure element, the sealing area interacts seal-tightly directly or indirectly with a free end face of the annular space socket;
wherein the fluid collecting pot has at least one drain opening for liquid arranged radially outside of the sealing area.

2. The liquid filter according to claim 1, wherein an axial expansion of the annular space socket is smaller than an axial expansion of the drain housing socket.

3. The liquid filter according to claim 1, further comprising an annular seal that is positioned axially between the free end face of the annular space socket and the sealing area of the fluid collecting pot.

4. The liquid filter according to claim 3, wherein the annular seal is a flat seal.

5. The liquid filter according to claim 1, wherein the closure socket has circumferentially arranged at least one through opening for the liquid, wherein in the closed state of the closure element, the at least one through opening is closed by the drain housing socket or the annular space socket and is opened when the closure element is opened.

6. The liquid filter according to claim 1, wherein the drain housing socket has circumferentially arranged at least one through opening for the liquid, wherein in the closed state of the closure element, the at least one through opening is closed by the closure element and is opened when the closure element is opened.

7. The liquid filter according to claim 1, wherein the drain housing socket has an outer thread and the closure socket has a matching inner thread.

8. The liquid filter according to claim 1, wherein an opening of the at least one vent line in an interior of the housing in the normal operating position of the liquid filter is spatially above a lowermost opening of the at least one outlet line in the interior of the housing.
